(19) United States
(12) Patent Application Publication
(10) Pub. No.: US 2013/0317901 A1
(43) Pub. Date: Nov. 28, 2013

(54) Methods and Apparatuses for Displaying the 3D Image of a Product

(71) Applicants: Xiao Yong Wang, Shanghai (CN); Gang Liu, Shanghai (CN)

(72) Inventors: Xiao Yong Wang, Shanghai (CN); Gang Liu, Shanghai (CN)

(73) Assignee: Xiao Yong Wang, Shanghai (CN)

(21) Appl. No.: 13/479,063

(22) Filed: May 23, 2012

(51) Int. Cl. G06F 17/00; G06Q 30/02; G06F 17/30

(52) U.S. Cl. 705/14.41; 235/375

(57) ABSTRACT

A method of displaying the 3D image of a product using an electronic device capable of capturing and displaying images comprises a code capturing step, an image procuring step, and an image displaying step. During the code capturing step, an information code on a printed media carrying the information of a product is captured. During the image procuring step, the information code is decoded for the information of the product and a 3D image of the product is retrieved from a remote location via a data transmission network. During the image displaying step, the 3D image of the product is displayed against a background, the background being a live image captured in real time or a static image retrieved from a previously saved file.

### TECHNICAL FIELD

The present invention relates to methods and apparatuses of displaying the 3D image of a product as well as a method of tracking the effectiveness of a printed or 2D advertisement.

### BACKGROUND

Advertisement is essential for the visibility of a product. Compared to other forms of advertisement such as TV commercials, printed advertisement suffers the drawbacks of being still and limited to 2D representations and thus less efficient for product promotion. Recent development in augmented reality technique allows enhancing customers' experience by supplementing and combining real world information of a product from a printed advertisement with computer-generated sensory input, such as sound, video, graphics or GPS data. For example, the Layar Vision offered by the company Layar enables the creation of layers and applications that recognize real world objects and display digital information on top of them. The company Blippar offers technique that recognizes a product printed in media such as newspapers and magazines and displays information regarding the product to customers. Metaio mobile SKD offered by the company Metaio provides a platform for a manufacturer or an advertisement agency to create mobile applications to present the products to customers in a more vivid way (such as 3D images).

The prevailing augmented reality technique, however, mainly focuses on enlivening the presented view of a product with additional computer generated information; it is still a one way effort made by a manufacturer or advertisement agency. The manufacturer or advertisement agency is more or less “shooting in the dark” as he does not have meaningful feedback or input from customers. Consequently, even though enhanced with augmented reality technique, the products are still presented to a customer in a way that although the manufacturer or advertisement agency thinks best caters customer needs but actually may not be what the customer desires to see.

### SUMMARY

It is an object of the present disclosure to enliven printed advertisement with a method and an apparatus that provides interaction between customers and manufacturers and advertisement agencies so that a customer can create a 3D view of a product against the background of their own choice and information of their own interest and manufacturers and advertisement agencies can collect feedback and other information from customers and thus can target specific customers more precisely and present products to customers in a more individualized way.

According to one aspect of the present disclosure, there is provided a method of displaying the 3D image of a product using an electronic device capable of capturing and displaying images. The method comprises a code capturing step, an image procuring step, and an image displaying step. During the code capturing step, an information code on a printed media carrying the information of a product is captured. During the image procuring step, the information code is decoded for the information of the product and a 3D image of the product is retrieved from a remote location via a data transmission network. During the image displaying step, the 3D image of the product is displayed against a background, the background being a live image captured in real time or a static image retrieved from a previously saved file.

According to another aspect of the present disclosure, there is provided an apparatus for displaying the 3D image of a product. The apparatus comprises an image capturing unit, a processing unit, and an image displaying unit. The image capturing unit is capable of capturing an information code on a printed media carrying the information of a product. The processing unit is connected to the image capturing unit and to a remote location via a data transmission network. The processing unit is capable of decoding the information code for the information of the product, obtaining, based on the decoded information of the product, a 3D image of the product from the remote location, obtaining, as the background to display the 3D image, a live image captured in real time or a static image retrieved from a previously file saved locally or in a remote location, and processing the 3D image and the background to produce a synthesized image displaying the 3D image against the background. The image displaying unit is connected to the processing unit, and is capable of receiving the synthesized image from the processing unit and displaying the synthesized image.

According to a further aspect of the present disclosure, there is provided a method for tracking the effectiveness of a printed advertisement that can be captured and identified by an electronic device capable of displaying a 3D image. The method comprises a code capturing step, an image procuring step, an image displaying step, and a display data collection step. During the code capturing step, an information code on a printed media carrying the information of a product is captured with the electronic device. During the image procuring step, the information code is decoded for the information of the product and a 3D image of the product is retrieved from a remote location. During the image displaying step, the 3D image of the product is displayed on the electronic device against a background, the background being a live image or a static image from a previously saved file; and a display data collection step, in which display data of the 3D image is recorded and saved.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 shows a method of displaying the 3D image of a product using an electronic device capable of capturing and displaying images;

FIG. 2 is a flow chart illustrating the process of displaying the 3D image of a product;

FIG. 3 shows a method of displaying the 3D image of a product using an electronic device capable of capturing and displaying images according to the second embodiment of the present disclosure;

FIG. 4 illustrates an apparatus for displaying the 3D image of a product according to the third embodiment of the present disclosure;

FIG. 5 illustrates a method for tracking the effectiveness of a printed advertisement that can be captured and identified by an electronic device capable of displaying a 3D image.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

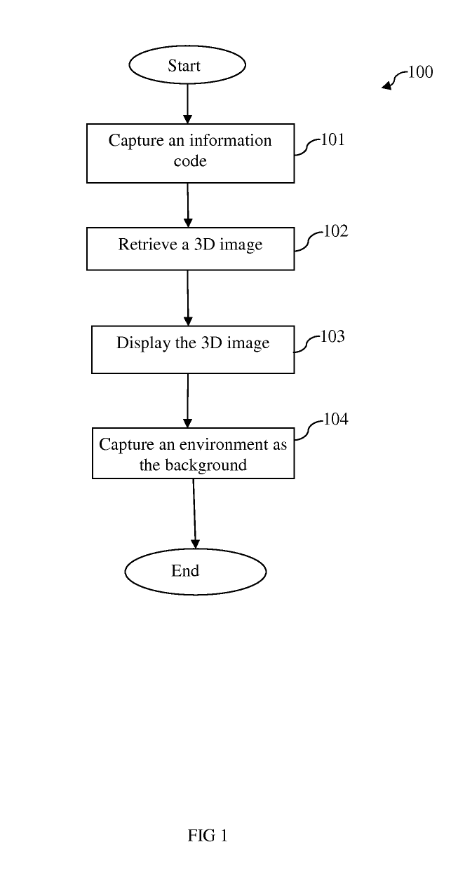

FIG. 1 shows a method 100 of displaying the 3D image of a product using an electronic device capable of capturing and displaying images. The electronic device can be a tablet computer such as Android or iPad, or a mobile device such as the Smart Phone with a built-in or attached camera. The products to be displayed in 3D images include a wide range of consumer goods, such as cars, household articles like refrigerators and washing machines, clothes, books, and laptop computers.

As shown in FIG. 1, the method 100 may comprise a code capturing step 101, an image procuring step 102, and an image displaying step 103.

At the code capturing step 101, an information code on a printed media carrying the information of a product is captured with the electronic device. The information code could be of any form that carries the information regarding a product, such as a bar code, a 2D code, a 3D code, or just an image of the product. The information code may be printed on a newspaper, a magazine, or a product pamphlet; it may also be painted outdoors on a newspaper kiosk, a cab, a highway bulletin, or a subway station. The information code may also be shown on a computer screen, a TV screen, or screens of any other electronics.

At the image procuring step 102, the information code captured in the code capturing step 101 is decoded for the information of the product. This can be done with well-known deciphering technology. For example, for a bar code, the decoding can be done with the barcode reading technology. As another example, a 2D code may be decoded by a computer program, such as an iPhone app, through matching the 2D code with a code in a local or remote database server. The information may include the name, serial number, manufacturer of a product, or any other information.

After the decoding, a 3D image of the product is retrieved from a remote location via a data transmission network. The 3D image may be 3D computer graphics that use a three-dimensional representation of geometric data (often Cartesian) that is stored in a storage device for the purposes of performing calculations and rendering 2D images; in other word, a 3D image herein means graphic data that can be calculated and rendered in a 2D screen from a plurality of perspectives. Herein, the 3D images are stored in a remote location, such as a database accessible to the public, often provided and maintained by an advertisement agency or a product distributor. A customer can access the location to retrieve the 3D images, e.g., using an iPhone app, via a data transmission network, which may be the internet, a LAN, or any network that is capable of transmitting data.

At the image displaying step 103, the 3D image of the product is displayed on the electronic device against a background. The background may be a live image captured by the electronic device in real time. The background can also be a static image retrieved from a previously saved file, which is stored in the image displaying device or stored in a remote location and retrieved via a data transmission network (internet, LAN, or any network capable of transmitting data). The background may be any image suitable for the product whose 3D image is to be displayed. For example, for a car, the background may be the garage of a customer or even the customer himself; while for a refrigerator or a bed, the background can be the interior of the kitchen or the bedroom of a house. Displaying the 3D image of a product against a background can deliver a more vivid representation of the product to a customer.

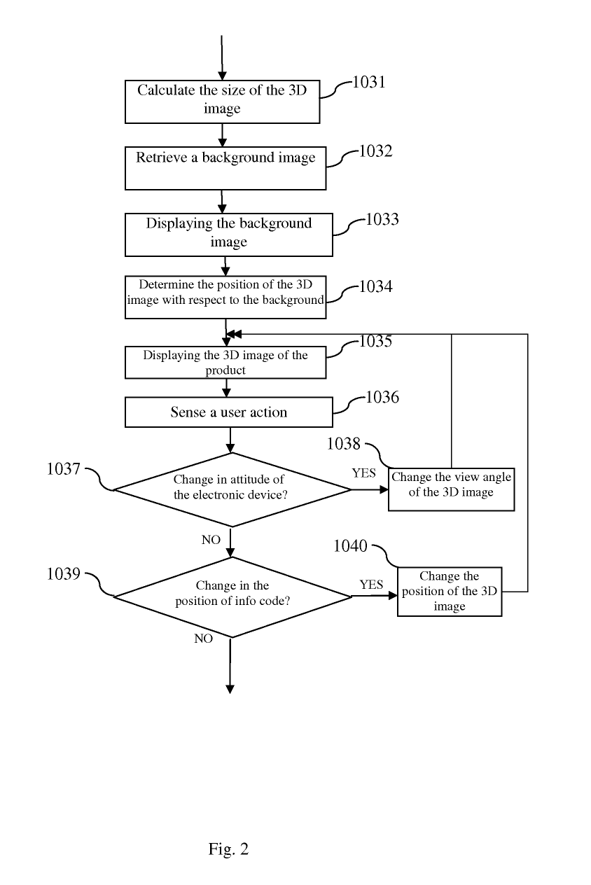

The 3D image may initially be displayed in one view angle; it may also be displayed from continuously varying view angles (i.e., being rotated). In addition, a customer can actively change the way of displaying of the 3D image, such as the view angle and the position of the 3D image, which will be described later with references to FIG. 2.

The method may further comprise a background capturing step 104 for capturing an environment in real time as the static image and saving the static image in a local or remote location. The background capturing step 104 can be performed at any time, for example, after the code capturing step 101, after the image procuring step 102, or after the image displaying step 103. As an example, in FIG. 1, the step 104 is performed after the image displaying step 103.

In addition to displaying the 3D image of the product and the background, relevant information of the product, such as the price, evaluation of other customers, the product's website, description of the parts of the product, and the manufacturer, can be displayed alongside with the 3D image or the background in a form such as a floating tag (floating with the 3D image of the product), a bar, or even sound voicing such information.

FIG. 2 is a flow chart illustrating the process of displaying a 3D image of a product.

At step 1031, the size of the 3D image is calculated based on the physical distance of the information code from the electronic device, which can be done by means of, for example, a camera matrix known to one skilled in the art.

At step 1032, an image is retrieved as the background for displaying the 3D image. As stated above, the background may be a live image captured by the electronic device in real time. The background can also be a static image retrieved from a previously saved file, which is stored in the electronic device or stored in a remote location and retrieved via a data transmission network (internet, LAN, or any network that is capable of transmitting data).

At step 1033, the background is displayed on the image displaying device.

At step 1034, the position of the 3D image of the product is determined based on the position of the information code captured by the electronic device with respect to the electronic device. For example, the position of the 3D image, usually represented by a vector, can be obtained by transforming the vector representing the position of the information code with a predetermined transform matrix.

Alternatively, other ways may be employed to determine the position of the 3D image with respect to the background. For example, it can be determined based on a user-specified position. The user can specify the position of the 3D image of the product by touching the background displayed on the display of the electronic device so as to choose where the product should be located.

At step 1035, the 3D image is displayed, with the size calculated as above and the position determined as above, against the background.

At step 1036, a user action is sensed by the electronic device. The kind of user action to be sense can be selected according to needs. For example, the change in the attitude of the device can be sensed so as to change the view angle of the 3D image of the product according to the change in the attitude of the electronic device; the change in the physical position of the information code captured by the device can be sensed so as to change the position of the 3D image of the product with respect to the background; the distance between the information code and the device may be sensed to as to change the size of the 3D image of the product according to the distance.

A decision 1037 determines whether the attitude of device is changed. When the decision 1037 determines that the attitude of the device is noticeably changed, the view angle of the 3D image is changed accordingly at step 1038, and the process goes back to the step 1035 to refresh the displayed 3D image of the product.

When the decision 1037 determines that the attitude of the device is not noticeably changed, a decision 1039 is made to determine whether the physical position of the information code captured by the device is changed (i.e., whether the use move the electronic device with respect to the information code). When the decision 1039 determines that position of the information code is changed, the position of the 3D image is changed accordingly at step 1040, and the process goes back to the step 1035 to refresh the displayed 3D image of the product.

The process illustrated in FIG. 2 initially shows the 3D image of the product with its size and position determined by the physical distance and position of the information code or specified by the customer. The size and position of the 3D image, as well as other features of the 3D image and features of the background, can instead be determined by artificial intelligence or intelligent judgment.

In the process illustrated in FIG. 2, the view angle and position of the 3D image are changed according to the user action sensed at the step 1036. Instead of that, the step 1036 can be substituted with a step of computer vision analysis based on a series of images of the code information code successively captured by the electronic device in the code capturing step 101, wherein the series of images of the information code are analyzed by means of computer vision to deduce whether and how the position, view angle, and distance of the information code with respect to the electronic device are changed; and depending on the deduced change of the position, view angle, and distance of the information code with respect to the electronic device, the position of the 3D image with respect to the background, the view angle of the 3D image of the product, and the size of the 3D image are varied. Computer vision, a field that includes methods for processing, analyzing, and understanding images, is known art and thus its detailed description is omitted.

The process illustrated in FIG. 2 only shows changing the way of displaying of the 3D image of a product in two aspects, i.e., changing the view angle and the position of the 3D image. However, one skilled in the art knows that the way for displaying the 3D image can be varied in many aspects. For example, the size of the 3D image can be changed according to the distance between the information code and the electronic device; the position of the 3D image of the product with respect to background can be changed according to the movement of the finger of a customer on the touch screen of the electronic device; the 3D image of the product can be zoomed in or zoomed out according to the relative movement of two fingers of the customer on the touch screen of the electronic device or according to the double clicking by the customer.

Moreover, the process can change the way the background is displayed just like changing the way the 3D image of the product as described above. For example, if the electronic device senses a user action for zooming in or zooming out the background (e.g., the movement of two fingers of the customer on the background image), the process will go back to the step 1033 and refresh the background image. Or the process can replace the background image being displayed with another one, in which case, the process goes back to the step 1032 and retrieve another background image.

In addition to displaying the 3D image of a product, the background, and the relevant information of the product, the screen of the electronic device can also display a GUI widget such as a toolbar, on which on-screen buttons, icons, menus, or other input or output elements are placed so that a customer can take pictures, share the images, purchase the product or pursue other activities by clicking the corresponding on-screen buttons, icons, menus, or other input or output element on the GUI widget.

The process described above comprises steps 1031 to 1040. To one skilled in the art, one or more steps can be saved or substituted with others. For example, step 1031 can be omitted, with the 3D image displayed at a predetermined size; or the step 1031 can be substituted with a step that determines the size of the 3D image according to the input of the customer. Furthermore, one skilled in the art can add more steps according to practical needs. For example, before the step 1032 the following step can be inserted: selecting a number of suitable background images based on the nature of the product, showing the icons of the selected background images for the customer to select the one he likes most.

In addition, sequences of different steps as illustrated in FIG. 2 can be varied; in other words, the steps 1031-1040 can be performed in an order different from that shown in FIG. 2. For example, the decision 1039 can be performed prior to the decision 1037. For another example, the step 1031 can be performed after the step 1032 so that the nature of the background image can be taken into account during calculation of the size of the 3D image of the product; or it can be performed after the step 1033.

Also, one skilled in the art understands that some steps as illustrated in FIG. 2 can be combined into one. For example, the step 1031 and the step 1034 can be combined into one, which, for example, determines the size and the position of the 3D image with one predetermined camera matrix based on the distance and position of the information code.

Moreover, the above mentioned steps 1031-1040 can be implemented as events. In other word, instead of being structured one by one as in FIG. 2, the steps may be events to be triggered and handled during displaying of the 3D images.

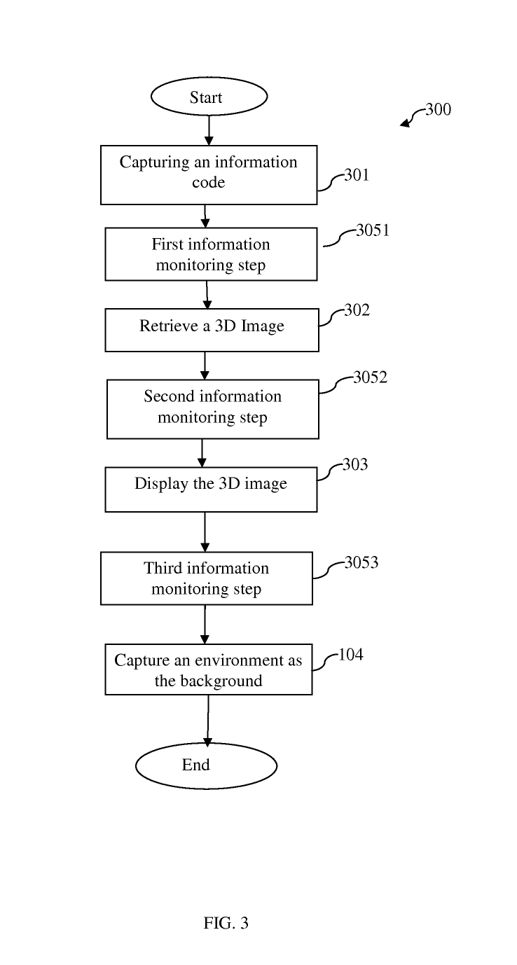

FIG. 3 shows a method 300 of displaying the 3D image of a product with an electronic device capable of capturing and displaying images according to the second embodiment of the present disclosure. The method according to the second embodiment also comprises the code capturing step 301, the image procuring step 302, and the image displaying step 303; the steps 301, 302, and 303 function similarly as the steps 101, 102, and 103 shown in FIG. 1 as described above and thus their detailed description will not be repeated. In addition to the steps 301, 302, and 303, the method 300 further comprises a first information monitoring step 3051 after step 301, a second information monitoring step 3052 after step 302, and a third information monitoring step 3053 after step 303. The first, second, and third information monitoring steps 3051, 3052, and 3053 monitor, respectively, the data obtained and generated in the code capturing step 301, the image procuring step 302, and the image displaying step 303; and may transmit the data obtained and generated to a server for further processing.

The first information monitor step 3051 obtains and gathers the information generated during capturing of an information code on a printed media. In one embodiment, the electronic device analyzes which medium (i.e., newspaper, magazine, product pamphlet, kiosk, cab, highway bulletin, or subway) the information code is located. In another embodiment, the electronic device will transmit the information to a remote server, and the remote server has a computer program that that compiles the data transmitted from different customers so as to extract knowledge such as which medium is most visible to customers.

In the second information monitoring step 3052, the data obtained and generated includes the information obtained through decoding the information code and the number of times the information code of the product is captured and decoded. In one embodiment, the computer program on the electronic device counts and records each time that it captures and decodes the information code. In another embodiment, the computer program will transmit the information to the remote server, and the computer program of the server counts and records each time the information code of the product is captured and decoded. In addition, since a user must log into the computer program before it displays 3D images, the specific user information may also be recorded, along with the number of times the information code of the product is captured and decoded.

In the third information monitoring step 3053, the data obtained and generated includes the start and end time the 3D image of the product is displayed. In one embodiment, the computer program on the electronic device records the start and end time the 3D image of the product that the device displays. In another embodiment, the computer program on the electronic device transmits the start and end time the 3D image of the product that it displays to a remote server.

The above data can be used to analyze the purchasing behaviors of customers or the efficiency of the advertisement. Specifically, in a traditional printed media, an advertiser has no idea regarding how many times the advertisement has been viewed by customers and how long did each customer view such advertisement. Consistent with the embodiments of the present invention, an advertiser knows who viewed the advertisement in a 3D image, how many times the advertisement has been reviewed, how long a specific customer viewed the advertisement in a 3D image, and which medium is the most visible to customers. Based on these data, an advertiser may modify and improve its advertising campaign such as selecting the right advertising medium and targeting those customers who have viewed the advertisement for a certain number of times and/or for a certain duration for follow-up.

The above description shows using the monitoring steps for data for analyzing the purchasing behaviors of customers or the efficiency of the advertisement. The steps can also be used for individualizing the 3D images and background delivered to the customers. For example, based on the information about the furniture one customer ever viewed, the remote server can analyze the customer's propensity regarding certain furniture, such as the color and the style, and in the future, the image procuring step can retrieve the proper 3D image of the furniture that best suit the customer's propensity. For another example, when purchasing furniture, a customer usually captures a picture of one room of his house as the background. The computer program on the electronic device may store the room pictures either locally or remotely so that next time the customer views a piece of similar furniture, the image displaying step can display the 3D image of the piece of furniture against the right room picture.

The method 300 as described above comprises three information monitoring steps 3051-3053. According to practical needs, one or two information monitoring steps can be saved or more information monitoring steps can be added.

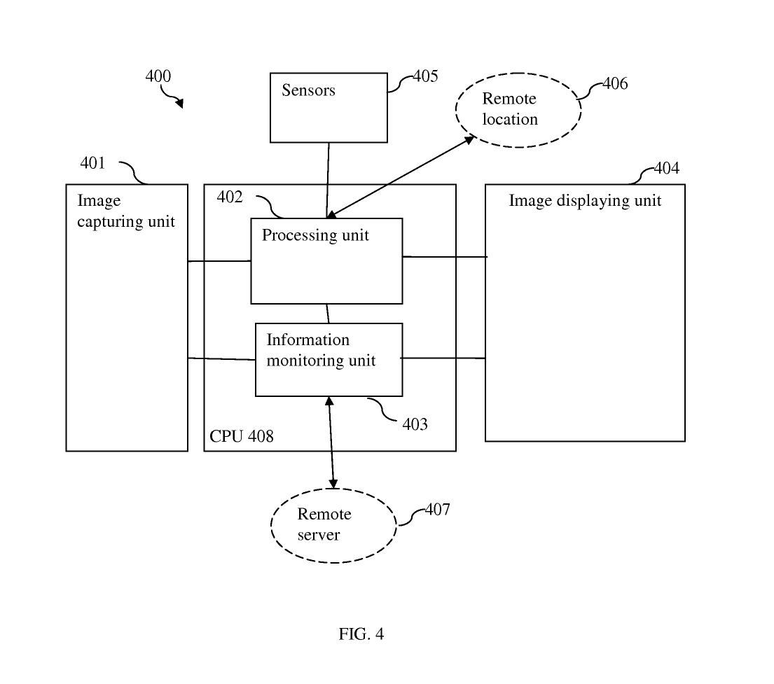

Furthermore, instead of being implemented sequentially as shown in FIG. 4, the information monitoring steps 3051-3053 can be implemented as events that are triggered by, respectively, the actions of capturing an information code, decoding the information code, retrieving the 3D image of a product, and displaying the 3D information.

FIG. 4 illustrates an apparatus for displaying the 3D image of a product according to the third embodiment of the present invention.

As shown in the FIG. 4, the apparatus 400 comprises an image capturing unit 401, a processing unit 402, an information monitoring unit 403, and an image displaying unit 404.

The image capturing unit 401 is capable of capturing an information code on a printed media carrying the information of a product. The information code could be of any form that carries the information regarding a product, such as a bar code, a 2D code, a 3D code, or just an image of a product. The information code may be printed on a newspaper, a magazine, or a product pamphlet; it may also be painted outdoors on a newspaper kiosk, a cab, a highway bulletin, or a subway station. The information code may also be shown on a computer screen, a TV screen, or the screens of any other electronics.

In addition, the image capturing unit 401 can capture an image in real time as the static image and send the image to the processing unit 402 to be described below, so that the static image can be saved in a local or remote location for future use.

The processing unit 402 is connected to the image capturing unit 401 and to a remote location 406 via a data transmission network. The processing unit 402 is capable of decoding the information code for the information of the product. It can also obtain, based on the decoded information of the product, a 3D image of the product from the remote location. Moreover, it can obtain, as the background to display the 3D image, a live image captured in real time or a static image retrieved from a previously file saved locally or in a remote location. The processing unit 402 can further process the 3D image and the background to produce a synthesized image displaying the 3D image against the background. In the synthesized image, relevant information of the product, such as the price, evaluation of other customers, the product's website, description of the parts of the product, and the manufacturer, can also be provided alongside with the 3D image or the background in a form such as a floating tag (floating with the 3D image of the product), a bar, or even sound voicing such information.

The processing unit 402 is also capable of determining the initial size and position of the 3D image according to the physical distance and position of the information code or specified by the customer. It can also determine the size and position of the 3D image, as well as other features of the 3D image and features of the background, through artificial intelligence or intelligent judgment.

The apparatus may further comprise a sensor 405 connected to the processing unit 402 for sensing user actions, so that the processing unit can receive user actions from the sensor and perform corresponding activities based on the user actions, for example, varying the view angle and the size of the 3D image of the product depending on the change of the attitude of the apparatus by the user. The sensor 405 can be of any form for sensing any user action. For example, it can be a touch screen for sensing the touching and movement of fingers or any other objects; or it can be a microphone for receiving the user's oral commands.

In fact, based on the information received from the sensor, the processing unit 402 can perform a variety of operations on the 3D image of the product and the background, among which are: calculating the size of the 3D image of the product based on the physical location of the information code, and processing the 3D image into the calculated size; determining the position of the 3D image with respect to the background on a user-specified position, and thus having the 3D image of the product displayed at the determined position in the synthesized image; changing the size of the 3D image according to the distance between the information code and the electronic device; changing the position of the 3D image of the product with respect to background according to the movement of the finger of a customer on the touch screen of the electronic device; zooming in or zooming out the 3D image of the product or the background image according to the relative movement of two fingers of the customer on the touch screen of the electronic device or according to the double clicking by the customer; and zooming in or zooming out the background image according to the movement of two fingers of the customer on the background image.

Moreover, the image capturing unit 401 is capable of successively capturing a series of images of the information code. And the processing unit is capable of analyzing the series of images of the information code by means of computer vision to deduce whether and how the position, view angle, and distance of the information code with respect to the electronic device are changed. And the image displaying unit is capable of, depending on the deduced change of the position, view angle, and distance of the information code with respect to the electronic device, varying the position of the 3D image with respect to the background, the view angle of the 3D image, and the size of the 3D image.

In addition, the processing unit can have the image displaying unit 404 display a GUI widget such as a toolbar, on which on-screen buttons, icons, menus, or other input or output elements are placed so that a customer can take pictures, share the images, or pursue other activities by clicking the corresponding on-screen buttons, icons, menus, or other input or output element on the GUI widget.

The image displaying unit 404 is connected to the processing unit 403. It receives the synthesized image from the processing unit and displays the image.

The information monitoring unit 403 is connected to the image capturing unit 401, the processing unit 402, and the image displaying unit 404 and is also connected to a remote server 407. The information monitoring unit 403 is capable of monitoring the data obtained and generated by the image capturing unit, the processing unit, and the image displaying unit, and is capable of transmitting the data obtained and generated to the remote server 407 for data processing. The remote server 407 may be provided and maintained by an advertisement agency or a product distributor; it may be located at the same place as the remote location 406.

The data obtained and generated by the information monitoring unit 403 includes the information obtained through decoding the information code and the number of times the information code of the product is captured and decoded. The data obtained and generated by the information monitoring unit 404 can also include the start and end time the 3D image of the product is displayed.

The processing unit 402 or the information monitoring unit 404 as described above can be a chip, such as an IC or a microprocessor, which comprises at least circuitry, memory, and processor for storing data and for performing the functions as described above for the units 402 and 404. The functions of the unit 402 or 404 as described above can be realized through programs stored and run in the chip.

In the above description, the processing unit 402 and the information monitoring unit 404 are described as separate parts; they can also be integrated as one unit. In addition, as shown in FIG. 4, the units 402 and 404 can be a part of a CPU 408; or the processing unit 402 and the information monitoring unit 404 can be virtual modules implemented in the CPU 408.

The apparatus described above can be a mobile device with a built-in or attached camera. For example, the apparatus can be a tablet computer such as Android or iPad, or a mobile phone such as the Smart Phones, in which case the processing unit 402 and the information monitoring unit 403 can be the virtual modules of the CPU of the tablet computer or the mobile phone.

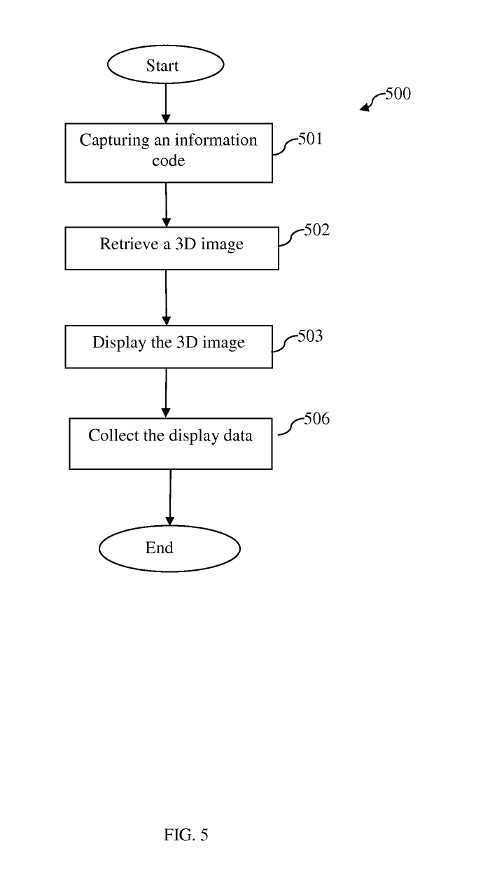

FIG. 5 illustrates a method 500 for tracking the effectiveness of a printed advertisement that can be captured and identified by an electronic device capable of displaying a 3D image. The printed advertisement contains a bar code, a 2D code, or a 3D code carrying the information of the product.

As shown in FIG. 5, the method 500 comprises a code capturing step 501, an image procuring step 502, an image displaying step 503, and a display data collection step 506. The steps 501, 502, and 503 function similarly as the steps 101, 102, and 103 of the method 100 described above and thus their detailed description is omitted.

The display data collection step 506 comprises: transmitting or saving the data to a local or remote location; analyzing the data for the effectiveness of the printed advertisement. In one embodiment, the computer program on the electronic device counts and records each time that it captures and decodes the information code. In another embodiment, the computer program will transmit the information to a remote server, and the remote server has a program that counts and records each time the information code of the product is captured and decoded. In addition, since a user must log into the computer program before it displays 3D images, the specific user information may also be recorded, along with the number of times the information code of the product is captured and decoded.

The display data collection step 506 comprises obtaining the display data including the start and end time the 3D images of the products are displayed. In one embodiment, the computer program on the electronic device records the start and end time the 3D image of the product that it displays. In another embodiment, the computer program on the electronic device transmits the start and end time the 3D image of the product that it displays to a remote server.

The above data can be used to analyze the purchasing behaviors of customers or the efficiency of the advertisement. Specifically, in a traditional printed media, an advertiser has no idea regarding how many times the advertisement has been viewed by customers and how long did each customer view such advertisement. Consistent with the embodiments of the present invention, an advertiser knows who viewed the advertisement in a 3D image, how many times the advertisement has been reviewed, how long a specific customer viewed the advertisement in a 3D image, and which medium is the most visible to customer. Based on these data, an advertiser knows whether a particular advertisement campaign is successful or not and how it compared to other advertisement campaigns. The advertiser also knows which customers are more interested in the advertised product based on the number of times these customers have viewed the advertisement and the duration that each of these customers reviewed the advertisement. As a result, the advertiser may modify and improve its advertising campaign such as selecting the right advertising medium and targeting those customers who have viewed the advertisement for a certain number of times and/or for a certain duration for follow-up.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

For example, the above embodiments generally describe displaying 3D images based on a 2D code on a printed advertisement. One skilled in the art would understand that the invention also discloses displaying 3D images based on a 2D code shown on a computer screen instead of a printed advertisement. One skilled in the art would also understand that the invention also discloses displaying 3D images based on a 2D code of an object, even though the object is not displayed for advertisement.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

We claim:

1. A method of displaying the 3D image of a product using an electronic device capable of capturing and displaying images, comprising:
a code capturing step, in which an information code on a printed media carrying the information of a product is captured;
an image procuring step, in which the information code is decoded for the information of the product and a 3D image of the product is retrieved from a remote location via a data transmission network;
an image displaying step, in which the 3D image of the product is displayed against a background, the background being a live image captured in real time or a static image retrieved from a previously saved file.

2. The method according to claim 1, wherein in the image displaying step, the size of the 3D image of the product is calculated based on the physical distance of the information code from the electronic device, and the 3D image of the product is displayed with the calculated size.

3. The method according to claim 1, wherein in the image displaying step, the position of the 3D image with respect to the background is determined based on a user-specified position, and the 3D image of the product is displayed at the determined position.

4. The method according to claim 1, wherein a series of images of the information code information code are successively captured by the electronic device, and in the image displaying step, the series of images of the information code are analyzed by means of computer vision to deduce whether and how the position, view angle, and distance of the information code with respect to the electronic device are changed, and depending on the deduced change of the position, view angle, and distance of the information code with respect to the electronic device, the position of the 3D image with respect to the background, the view angle of the 3D image, and the size of the 3D image are varied.

5. The method according to claim 1, wherein
the device is capable of sensing a user action;
in the image displaying step, a user action is sensed; and
in the image displaying step, depending on the sensed user action, at least one of the position of the 3D image with respect to the background, the view angle of the 3D image of the product, and the size of the 3D image of the product is varied.

6. The method according to claim 1, further comprising a background capturing step, in which a picture is captured in real time as the static image and saved in a local or remote location.

7. The method according to claim 1, further comprising at least one of the following steps: a first information monitoring step after the code capturing step, a second information monitoring step after the image procuring step, and a third information monitoring step after the image displaying step, wherein the first, second, and third information monitoring steps monitor, respectively, the data obtained and generated in the code capturing step, the image procuring step, and the image displaying step and transmit the data obtained and generated to a remote server for processing.

8. The method according to claim 7, wherein in the second information monitoring step, the data obtained and generated includes the information obtained through decoding the information code and the number of times the information code of the product is captured and decoded.

9. The method according to claim 7, wherein in the third information monitoring step, the data obtained and generated includes the start and end time the 3D image of the product is displayed.

10. The method according to claim 7, wherein the information monitored and transmitted by the first, second, and third information monitoring steps are used to analyze the propensity of a customer toward the product so that in the image procuring step, a 3D image of the product that suits the propensity is retrieved, and in the image displaying step, the 3D image is displayed against a background that suits the propensity.

11. The method according to claim 1, wherein the electronic device is a mobile device with a built-in or attached camera.

12. The method according to claim 1, wherein the information code is a bar code, a 2D code, or a 3D code.

13. An apparatus for displaying the 3D image of a product, comprising an image capturing unit, a processing unit, and an image displaying unit, wherein
the image capturing unit is capable of capturing an information code on a printed media carrying the information of a product;
the processing unit is connected to the image capturing unit and to a remote location via a data transmission network, the processing unit is capable of decoding the information code for the information of the product, obtaining, based on the decoded information of the product, a 3D image of the product from the remote location, obtaining, as the background to display the 3D image, a live image captured in real time or a static image retrieved from a previously file saved locally or in the remote location, processing the 3D image and the background to produce a synthesized image displaying the 3D image against the background; and
the image displaying unit is connected to the processing unit, and is capable of receiving the synthesized image from the processing unit and displaying the synthesized image.

14. The apparatus according to claim 13, wherein the processing unit is capable of calculating the size of the 3D image of the product based on the physical distance of the information code from the electronic device, and processing the 3D image into the calculated size.

15. The apparatus according to claim 13, wherein the processing unit is capable of determining the position of the 3D image with respect to the background on a user-specified position, and thus having the 3D image of the product displayed at the determined position in the synthesized image.

16. The apparatus according to claim 13, wherein the image capturing unit is capable of successively capturing a series of images of the information code, the processing unit is capable of analyzing the series of images of the information code by means of computer vision to deduce whether and how the position, view angle, and distance of the information code with respect to the electronic device are changed, and the image displaying unit is capable of, depending on the deduced change of the position, view angle, and distance of the information code with respect to the electronic device, varying the position of the 3D image with respect to the background, the view angle of the 3D image, and the size of the 3D image.

17. The apparatus according to claim 13, further comprising a sensor connected to the processing unit for sensing a user action, wherein the processing unit is capable of receiving the information regarding the user action from the sensor and is capable of, depending on the sensed user action, varying the view angle, the size of the 3D image of the product, or the position of the 3D image with respect to the background in the synthesized image.

18. The apparatus according to claim 13, the image capturing unit is capable of capturing an image in real time as the static image and saving the static image in a local or remote location.

19. The apparatus according to claim 13, further comprising a information monitoring unit connected to the image capturing unit, the processing unit, and the image displaying unit and connected to a remote server, wherein the information monitoring unit is capable of monitoring the data obtained and generated by the image capturing unit, the processing unit, and the image displaying unit, and is capable of transmitting the data obtained and generated to the remote server for processing.

20. The apparatus according to claim 19, wherein the data obtained and generated includes the information obtained through decoding the information code and the number of times the information code of the product is captured and decoded.

21. The apparatus according to claim 19, wherein the data obtained and generated includes the start and end time the 3D image of the product is displayed.

22. The apparatus according to claim 13, wherein apparatus is a mobile device with a built-in or attached camera.

23. The apparatus according to claim 13, wherein the information code is a bar code, a 2D code, or a 3D code.

24. A method for tracking the effectiveness of a printed advertisement that can be captured and identified by an electronic device capable of displaying a 3D image comprising:
a code capturing step, in which an information code on a printed media carrying the information of a product is captured with the electronic device;
an image procuring step, in which the information code is decoded for the information of the product and a 3D image of the product is retrieved from a remote location via a data transmission network;
an image displaying step, in which the 3D image of the product is displayed on the electronic device against a background, the background being a live image or a static image from a previously saved file; and
a display data collection step, in which display data of the 3D image is recorded and saved.

25. The method according to claim 24, wherein the display data collection step comprises:
transmitting the data to a remote server;
analyzing the data for the effectiveness of the printed advertisement.

26. The method according to claim 24, wherein
the printed advertisement contains a bar code, a 2D code, or a 3D code carrying the information of the product.

27. The method according to claim 24, wherein
the display data collection step comprises obtaining the display data including the start and end time the 3D images of the products are displayed.
